(19) United States
(12) Patent Application Publication
(10) Pub. No.: US 2003/0047953 A1
(43) Pub. Date: Mar. 13, 2003

(54) Releasable snap hook clasp

(76) Inventors: Thomas G. Hechimovich, Hartford, WI (US); Steve Simpson, Neosho, WI (US)

Correspondence Address: Philip J. Lee, Suite 525, 10050 Regency Circle, Omaha, NE, 68114, US

(21) Appl. No.: 10/167,828

(22) Filed: Jun. 12, 2002

Related U.S. Application Data
(60) Provisional application No. 60/322,061, filed on Sep. 11, 2001.

(51) Int. Cl. B25J 1/04

(52) U.S. Cl. 294/19.1

(57) ABSTRACT

A clasp for releasably grasping a snap hook to aid attachment of said hook to a remote eyelet, the clasp adapted to be mounted on a pole and comprising a flexible, curved and grooved member shaped to receive and partially and releasably encircle the outer surface of a snap hook such that the hook opening faces away from the pole.

### CROSS REFERENCE TO RELATED PROVISIONAL APPLICATION

This application claims the benefit of U.S. Provisional Application No. 60/322,061, filed Sep. 11, 2001.

### BACKGROUND OF THE INVENTION

A. Field of invention

The present invention relates generally to a device for releasably grasping a hook and more particularly to a new and improved releasable hook clasp.

B. Description of Related art

It is frequently necessary for an individual to secure a line to an eyelet fitting at a position remote from the individual. Examples of such circumstances include attaching a boat mooring line to a mooring buoy and attaching a trailer mounted winch line to the bow eyelet fitting on a boat to be placed on the trailer. Frequently a snap hook may be used as a line end device to secure the line to the eyelet. Common snap hooks comprise a hook with an eye or other means for securing the line at its base and a hook section that extends from the base around a curved bight and ending in a tine which extends toward but does not meet the base, leaving an opening, which is traversed by a spring-loaded latch. The latch is frequently pivotable at or near the base and is spring-biased toward the hook tine with which the latch engages so as to open inwardly, but not outwardly. The common manner of using the snap hook to secure a line to an eyelet is to pass the hook tine through the eye so that the bight of the hook secures the ring of the eyelet. The latch is provided to prevent the unintended removal of the hook from the eye.

Examples of devices designed to facilitate the attachment of common snap hooks, sometimes referred to as latch hooks, to remote fittings are shown in U.S. Pat. No. 6,193,432 to Kampfert, in U.S. Pat. No. 4,986,207 to Reed, in U.S. Pat. No. 5,215,334 to Augustyniak, and U.S. Pat. No. 5,190,330 to Dunham. The configurations of these snap hook clasps are of two types. One type involves gripping the snap hook so as to present the outside surface of the hook bight as the leading and foremost element with the hook opening toward the individual, as seen in Kampfert and Augustyniak. The other type involves gripping the snap hook so as to present the hook sideways to the eyelet to be secured, as seen in Reed and Dunham. Both of these types employ an orientation of the hook relative to the eyelet that is similar to that naturally used when the hook is grasped in the individual's hand. When hand held, the snap hook is normally grasped at or near the base, secured to the line, which is toward the individual with the opening of the hook more or less toward the individual. In this handheld orientation, the ring of the eyelet is engaged by passing the hook tine through the ring, which is immediately restrained by the bight of the hook. This is convenient and efficient when the snap hook is held by hand; however, when a mechanical device at the end of a long pole clasps the hook, the required manipulation becomes relatively complex. The required hook manipulation operator is particularly difficult in light of the amplification of the movements made by the individual at the opposite end of the pole. Specifically, the devices that present the hook with the opening toward the individual must be manipulated to extend the hook past the eye to be secured and then draw the hook diagonally laterally and backward toward the individual.

The second type of hook clasp extends the hook in a sideways orientation, normal to the pole and thus requires a lateral sweep of the hook to pass the hook tine through the eye to engage the eyelet. This maneuver, being an angular movement of a long pole pivoting at its end held by the individual, is also characterized by a magnification of the movement induced by the individual. Both types of devices present the increased chance of an accidental impact of the hook with areas around the eye such as the bow of a boat. The manipulation of the pole mo0nted devices must therefore be precise and if not immediately successful are extremely tiring with the success rate of repeated attempts expected to rapidly diminish.

Accordingly there is a need for a simple and lightweight improved releasable snap hook clasp that can be mounted on a pole to facilitate attachment of a snap hook to an inaccessible or remote eye. The specific need is for a device by which an operator can easily attach a winch line from a boat trailer to the bow eye of a boat, which is to be loaded onto the trailer, although numerous other applications are anticipated as well.

### SUMMARY OF THE INVENTION

The device of the present invention comprises a clasp for releasably grasping a snap hook, the clasp being adapted to be mounted on a pole, which may be telescoping. The clasp is generally planar and shaped to releasably engage a conventional snap hook by gripping the outside surface of the bight of the hook so that the hook opening faces away from the pole and the latch opens by pivoting inwardly toward the pole. The ring of an eyelet to be engaged is secured by the snap hook by passing a segment of the eyelet ring through the snap hook opening past the latch. The tine of the snap hook either does not initially pass through the ring of the eyelet or is guided therethrough by the contact of the ring segment with the latch.

The hook clasp of the present invention is curved and formed with an inside surface generally conforming to the outer surface of the bight of a common snap hook. The curved clasp extends over slightly more than a semicircular, 180 degree, arc to partially enclose the snap hook bight and to define an opening. The clasp is sufficiently flexible to allow the clasp opening to expand to allow the hook to enter and be received within the clasp. The inner surface of the curved clasp is formed with an angular, “V” shaped groove, the inner surface being generally bilaterally symmetrical across the plane described by the bottom of the groove. The groove shape allows the inner surface to accommodate and securely grip snap hooks of different sizes. The flexibility of the clasp also allows a range of hook sizes to be received. The clasp is also resilient, and by regaining or attempting to regain its original shape, securely grasps the snap hook.

The device comprises a base, which is adapted for mounting on the end of a pole such that the opening of the curved clasp faces away from the pole. When an individual operator holds the opposite end of the pole, the clasp opening faces away from the operator. The orientation of the clasp to the pole is such that the latched opening of a snap hook grasped by the device faces relatively directly away from the pole end and the individual operator. Therefore the snap hook latched opening is presented directly and first toward the eyelet to be engaged, the latched opening being normal to the pole and the latch opens by pivoting toward the individual. The orientation of the snap hook relative to the operator and the eyelet is reversed from the conventional orientation and from the eventual deployment of the snap hook. In operation, the operator extends the devise with clasped snap hook directly toward the eye to be engaged which directly impacts and opens the latch. The operator does not need to make any lateral or angular adjustments or manipulations to engage the snap hook to the eye by passing the hook tine through the eye. Once the ring of the eyelet is within the interior of the snap hook and the eyelet has been captured, a pull on the pole disengages the device from the snap hook and the operation is complete.

The device may be conveniently formed by molding or tooling a range of materials, which are selected for an appropriately resilient and flexible nature. The material must have sufficient flexibility to open to receive a snap hook having a bight slightly larger than the area enclosed by the curved clasp when relaxed. Further, the material needs sufficient resiliency to regain and attempt to regain its original shape when distorted or expanded by a hook. The resiliency of the clasp causes the hook to be retained by the clasp while the flexibility allows the clasp to engage and disengage the hook. The curved member may also be conveniently formed of two pieces with a joint between a relatively stiff base member and a relatively flexible hook engaging curved member. The base member forms the base for the attachment to the pole, either by means of a socket formed in the end of the pole for receiving a shaft on which the base is mounted, or a socket formed in the base section in which the pole end is received. The base member comprises a straight section extending from the clasp opening, which acts as a guide for the hook entering the clasp and the base member overall describes about not more than a 90 degree arc. The curved member describes an arc of more than 90 degrees such that the clasp as a whole describes an arc of more than 180 degrees. The base and curved members are joined by disjoinable means such as screw or bolt, and a curved member of one size can be exchanged for a curved member of another size to accommodate different sized hooks. The junction between the two clasp sections may be spring loaded or otherwise adapted to increase the range of hook sizes that can be accommodated or to modify the clasping force with which the device grips the snap hook

The principle aim of the present invention is to provide a new and improved snap hook clasp, which meets the foregoing requirements and is capable of being mounted on a pole for remote operation.

Another and further object and aim of the present invention is to provide a new and improved snap hook clasp, which meets the foregoing requirements and which is lightweight.

Another and further object and aim of the present invention is to provide a new and improved snap hook clasp, which meets the foregoing requirements and which is economical to manufacture and easy to operate.

Other objects and advantages of the invention will become apparent from the Description of the Preferred Embodiments and the Drawings and will be in part pointed out in more detail hereinafter.

The invention consists in the features of construction, combination of elements and arrangement of parts exemplified in the construction hereinafter described and the scope of the invention will be indicated in the appended claims.

### BRIEF DESCRIPTION OF THE DRAWINGS

FIG. 1 is a side view of a first preferred embodiment of a snap hook clasp constructed in accord with the present invention with hook inserted therein.

FIG. 2 is a side view of a first preferred embodiment of a snap hook clasp constructed in accord with the present invention with hook in position to be inserted therein.

FIG. 3A is a side view and FIG. 3B is an end view of a first preferred embodiment of a snap hook clasp constructed in accord with the present invention.

FIG. 4A is a side view and FIG. 4B is an end view of a jaw member of a first preferred embodiment of a snap hook clasp constructed in accord with the present invention.

FIG. 5A is a side view and FIG. 5B is an end view of another jaw member of a first preferred embodiment of a snap hook clasp constructed in accord with the present invention.

FIG. 6 is a side view of a second embodiment of a snap hook clasp constructed in accord with the present invention with hook inserted therein and the clasp mounted on a pole.

### DESCRIPTION OF THE PREFERRED EMBODIMENT(s)

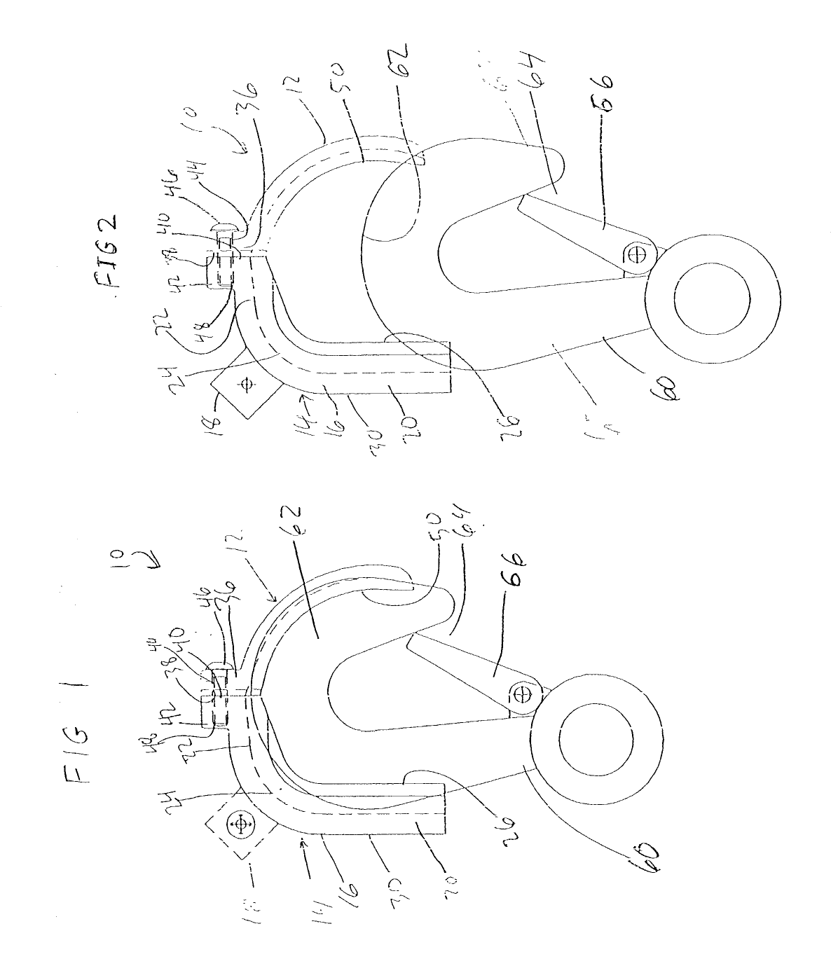

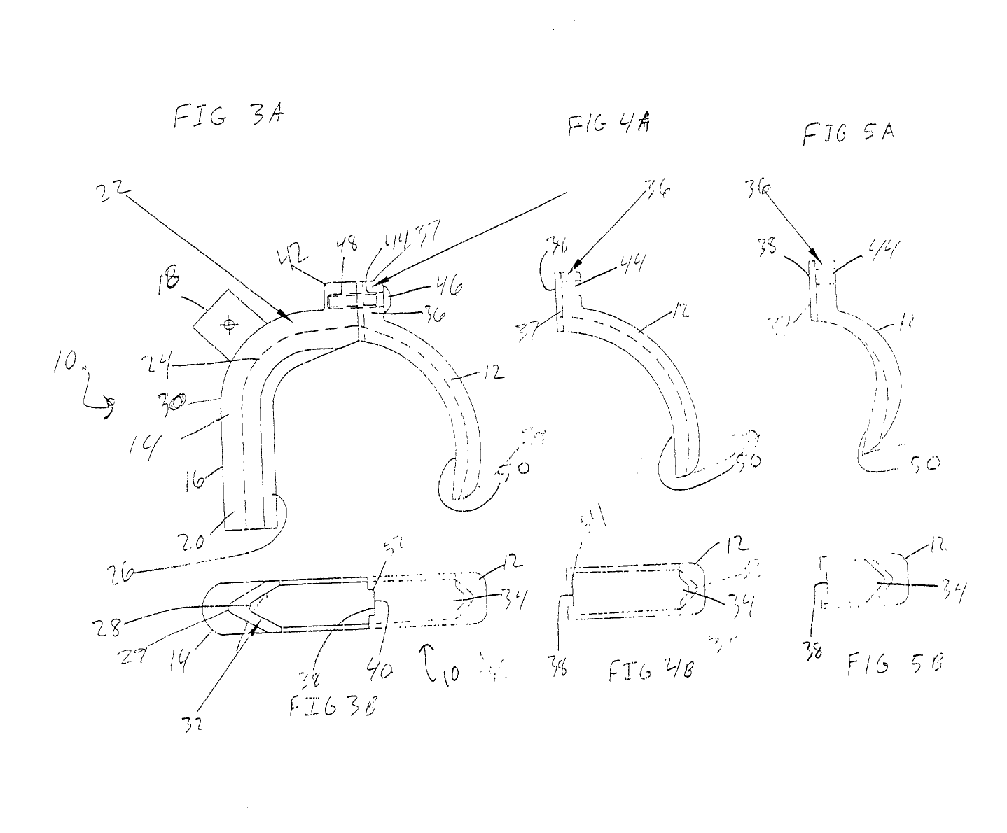

With reference to the Drawings wherein like numerals represent like parts throughout the Figures, a device in accord with the present invention is generally designated by numeral 10 in FIGS. 1, 2, 3A and 3B. A first preferred embodiment of a snap hook clasp 10 comprises a curved member 12 and a base member 14.

Base member 14 comprises a pole engaging post 18 and a hook engaging section 16. The base member section 16 comprises a relatively long straight track 20 and a relatively short track 22 and a radiused section 24 between tracks 20 and 22 joining tracks 20 and 22 in approximately a right angle relationship. Tracks 20 and 22 and section 24 are continuous and form a continuous inner surface 26 having a groove 28 running the entire inner surface 26 and having a cross-sectional “V” shape with straight sides 32 at an acute angle to each other. Base member 14 is generally bilaterally symmetrical across the plane defined by the bottom 29 of groove 28. Post 18 protrudes from the outer surface 30 of base member section 16 at the radiused section 24, the axis of post 18 being approximately normal to the tangent of radiused section 24. Base member 14 is formed as a single piece from plastic or other easily worked material of sufficient strength, and may be but need not be resilient and flexible.

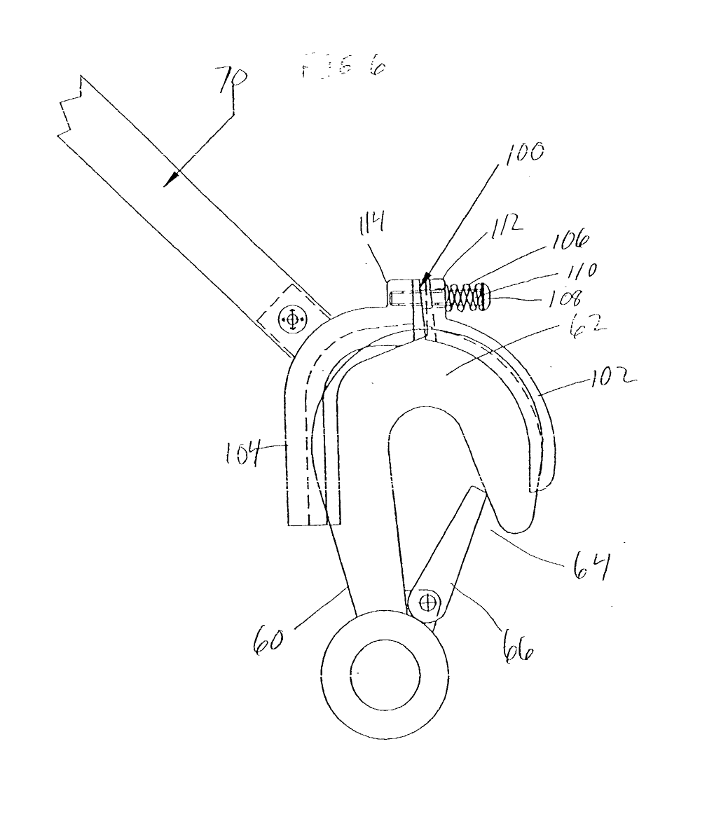

Curved member 12 is generally shaped as an arc of slightly more than 90 degrees and of a radius greater than the radiused section 24 of the base member section 16. Curved member 12 comprises an inner surface 50 of about the same width as base member inner surface 26. Inner surface 50 forms a groove 34 similar to base member groove 28, having a bottom 33 and sides 35 in a “V” shaped cross section, in similar shape and size. Curved member 12 is generally symmetrical across the plane defined by groove bottoms 29 and 33, which are coplanar. The ends of grooves 28 and 34 are open and grooves 28 and 34 are joined and continuous when the device 10 is assembled. One end 37 of curved member 12 forms a flange 36 having a surface 38 which is generally normal to the tangent of the curve of member 12 and which corresponds to an opposing surface 40 formed by a flange 42 at the end of short base member track 22. A hole 44 drilled in curved member flange 36 through surface 38 accepts a screw 46 which engages a threaded bore 48 in base member flange 42 to removably secure curved member 12 to base member 14. Removability of curved member 12 allows interchange and substitution of other sizes of members 12 as shown in FIGS. 4 and 5. In the illustrated preferred embodiment, base member flange surface 40 comprises a protruding key 52, which fits in a corresponding recess 54 in surface 38 to assure proper alignment of the members 12 and 14. Curved member 12 is formed of a flexible and resilient material and has a thickness that is somewhat less than that of base member 14 and may be thicker at flange end 37 that at the opposite end 39. When curved member 12 is secured to base member 14, base member and curved member grooves 28 and 34 are continuous and coplanar and extend through an arc of more than 180 degrees, while generally conforming to the outer surface of the bight of a common snap hook. In the assembled device 10, curved member end 39 forms one side and the end of longer straight base member track 20 forms the other side of a mouth or opening into which a common snap hook can be introduced. Curved member end 39 is thinned to allow easier entrance of a hook into the clasp mouth.

In the preferred embodiment, the entire device 10 is formed of an acetal resin such as Delrin, Registered Trademark of E. I. du Pont de Nemours and Company, and it is to be expected that other engineering polymers and materials could be used with similar results, provided that the material used is sufficiently flexible.

When assembled together, members 12 and 14 securely but releasably enclose and clasp the outer surface of the bight 62 of a snap hook or carabiner, an example of which is identified by the numeral 60 in FIGS. 1, 2 and 6, having a bight 62, tine 63, latched opening 64 and shank section 65. The assembled device 10 is intended to be mounted on a pole end such as shown in FIG. 6 and identified by the numeral 70. When the device 10 is used, the bight 62 of a snap hook or carabiner is inserted within the inner surfaces 26 and 50 and gripped within grooves 28 and 34. Hook 60 is oriented within device 10 with hook shank section 65 engaged by base member track 20 and hook bight 62 engaged by curved member 12 such that the latched opening 64 of the hook 60 faces away from the pole 70 in the same direction as the mouth of device 10. Base member 14 is sized to accommodate a relatively wide range of commonly anticipated hook sizes and a curved section 12 is selected of appropriate size for a relatively narrower range of hook sizes, such that the snap hook or carabiner 60 forces curved member 12 to flex in the dimension of the plane defined by the bottoms 29 and 33 of grooves 28 and 34 to widen or open the mouth of device 10 and allow full insertion of the bight of hook 60. After full insertion of the hook 60 into the device 10, the resulting partial encirclement of the hook 60 and the force exerted against the hook by the resilient jaw member 12, which may not be fully relaxed, retains the hook 60 within device 10.

Device 10 is intended to be used by an individual who desires to secure the hook 60 to a remotely located eye (not shown) and does so by manipulating the pole 70 until the ring of the eye forces open the hook latch 66 and passes through the hook opening 64 far enough to allow the latch 66 to close. The device 10 is then removed from the hook 60 by a pull on the pole 70 by the individual operator, which causes curved member 12 to again flex, widening the mouth of device 10 to allow the hook 60 to be released.

A second embodiment of the invention is shown in FIG. 6 as clasp 100. Clasp 100 comprises a curved member 102 and a base member 104 which are similar to members 12 and 14, the main difference between device 10 and clasp 100 being that the junction between the two members 102 and 104 is spring loaded by means of a spring 106 compressed,between the head 108 of a screw 110 and the flange 112 of curved member 102. Clasp 100 is able to adjust to the size or shape of the inserted hook or carabiner by separation of the flange 114 of the base member 104 from the curved member flange 112 by further compression of spring 106.

It will be anticipated that means of securing clasps 10 or 100 to a pole other than by post 18 can be used to equal advantage, such as by forming a socket in place of post 18.

It will be further anticipated that device 10 could be formed in one piece in the event the interchangeability of curved members of different sizes is not required.

While preferred embodiments of the foregoing invention have been set forth for purposes of illustration, the foregoing description should not be deemed a limitation of the invention herein. Accordingly, various modifications, adaptations and alternatives may occur to one skilled in the art without departing from the spirit and the scope of the present invention.

1. A device for releasably grasping a hook having a curved bight and a latched opening, the device comprising a curved clasp formed with an inside surface generally conforming to the outer surface of the bight of a hook.

2. The device of claim 1, further comprising a pole engaging end adapted to mount the device on the end of a pole.

3. The device of claim 2, wherein the clasp further comprises an opening adapted receiving a hook and the clasp opening faces away from the pole engaging end, such that the opening of a hook secured within the clasp faces away from a pole engaged in the pole engaging end.

4. The device of claim 3, wherein the curved clasp is flexible and resilient and extends over an arc of more than 180 degrees, whereby the clasp opening is adapted to temporarily widen to allow the bight of a hook to enter the clasp.

5. The device of claim 4, wherein the inner surface of the curved clasp comprises a groove extending along the inner surface

6. The device of claim 5, wherein the tool comprises a base, which is adapted for mounting on the end of a pole such that the opening of the curved clasp faces away from the pole

7. The device of claim 6, wherein the clasp comprises a base member having a straight section extending to the clasp opening and a curved section, the pole engaging end being positioned at the juncture of the straight section and the curved section, and wherein the clasp further comprises a curved member disengagably secured to the curved section of the base member.

8. The device of claim 7, wherein the curved clasp member is more flexible than the base member.

9. The device of claim 7, wherein the curved clasp member is loosely attached to the base member such that the curved member and the base member are allowed to separate to widen the clasp opening and the device further comprises spring means to urge the closure of the clasp opening.

10. A device for releasably grasping a hook having a curved bight and a latched opening, the device comprising an arcuate clasp with an opening and an inside surface extending through an arc of more than 180 degrees, the opening being resiliently widenable.

11. The device of claim 10, further comprising a pole engaging end adapted to mount the device on the end of a pole with the clasp opening facing away from the pole.

12. The device of claim 11, wherein the inner surface of the curved clasp comprises a groove extending along the inner surface and comprising flat sides from the bottom of the groove to the edges of the clasp.

13. The device of claim 12, wherein the clasp comprises a base member having a straight section extending to the clasp opening and a curved section, the pole engaging end being positioned at the juncture of the straight section and the curved section, and wherein the clasp further comprises a curved member replaceably attached to the base member.

14. The device of claim 13, wherein the curved clasp member is loosely attached to the base member such that the curved member and the base member are allowed to separate and the clasp opening is allowed to widen, and the device further comprises spring means to urge the closure of the clasp opening.

15. The device of claim 13, wherein the curved clasp member is more flexible than the base member.
